(19) United States
(12) Patent Application Publication
(10) Pub. No.: US 2009/0198537 A1
(43) Pub. Date: Aug. 6, 2009

(54) Defining An SOA Strategy For A Service Oriented Architecture

(75) Inventors: William A. Brown, Raleigh, NC (US); Kerrie L. Holley, Montara, CA (US); Garrison A. Moore, Uxbridge (CA); William J. Tegan, Oakland, CA (US)

Correspondence Address: BIGGERS & OHANIAN (END), C/O BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/025,340

(22) Filed: Feb. 4, 2008

(51) Int. Cl. G06Q 10/00

(52) U.S. Cl. 705/7

(57) ABSTRACT

Methods and systems for defining SOA strategy for a Service Oriented Architecture (‘SOA’) are described that include identifying, in dependence upon a business's SOA vision and one or more artifacts describing a current state of a business's SOA, one or more SOA opportunity areas for the business; assessing a current service maturity level of the business's SOA; determining a target service maturity level for the business's SOA; and developing an SOA strategic plan to reach the target service maturity level for the business's SOA, the SOA strategic plan including an identification of the one or more SOA opportunity areas for the business.

### BACKGROUND OF THE INVENTION

1. Field of the Invention

The field of the invention is data processing, or, more specifically, methods and systems for defining SOA strategy for a Service Oriented Architecture (‘SOA’).

Description Of Related Art

Service Oriented Architecture (‘SOA’) is an architectural style that guides all aspects of creating and using business processes, packaged as services, throughout their lifecycle, as well as defining and provisioning the IT (‘information technology’) infrastructure that allows different applications to exchange data and participate in business processes loosely coupled from the operating systems and programming languages underlying those applications. SOA represents a model in which functionality is decomposed into distinct units (services), which can be distributed over a network and can be combined together and reused to create business applications. These services communicate with each other by passing data from one service to another, or by coordinating an activity between two or more services. The concepts of Service Oriented Architecture are often seen as built upon, and the evolution of, the older concepts of distributed computing and modular programming. Although services and a business's SOA architecture are often strictly defined, governance of an SOA, implementation of an SOA, operation of an SOA, and management of an SOA is often not defined. A defined model of governance, however, may increase effectiveness and efficiency in implementing, operating, and managing a business's SOA, thereby providing savings to the business.

### SUMMARY OF THE INVENTION

Methods and systems for defining SOA strategy for a Service Oriented Architecture (‘SOA’) are described that include identifying, in dependence upon a business's SOA vision and one or more artifacts describing a current state of a business's SOA, one or more SOA opportunity areas for the business; assessing a current service maturity level of the business's SOA; determining a target service maturity level for the business's SOA; and developing an SOA strategic plan to reach the target service maturity level for the business's SOA, the SOA strategic plan including an identification of the one or more SOA opportunity areas for the business.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram of a system for defining SOA strategy for an SOA according to embodiments of the present invention.

FIG. 2 sets forth a flow chart illustrating an exemplary method for defining SOA strategy for an SOA according to embodiments of the present invention.

FIG. 3 sets forth a flow chart illustrating a further exemplary method for defining SOA strategy for an SOA according to embodiments of the present invention.

### DETAILED DESCRIPTION OF EXEMPLARY EMBODIMENTS

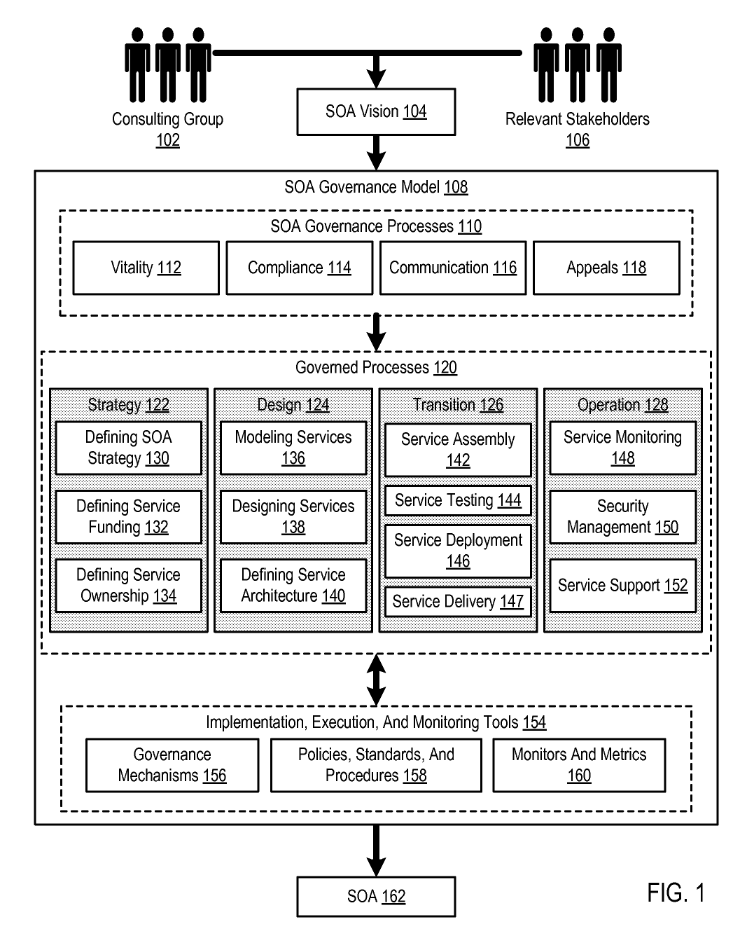

Exemplary methods and systems for defining SOA strategy for an SOA in accordance with the present invention are described with reference to the accompanying drawings, beginning with FIG. 1. FIG. 1 sets forth a block diagram of a system for governing a Service Oriented Architecture (‘SOA’) that includes a process of defining SOA strategy for an SOA according to embodiments of the present invention. SOA is an architectural style that guides all aspects of creating and using business processes, packaged as services, throughout their lifecycle, as well as defining and provisioning the information technology (‘IT’) infrastructure that allows different applications to exchange data and participate in business processes loosely coupled from the operating systems and programming languages underlying those applications. SOA represents a model in which functionality is decomposed into distinct units, called services, which can be distributed over a network, can be combined together, and reused to create business applications. These services communicate with each other by passing data from one service to another, or by coordinating an activity between two or more services. The concepts of Service Oriented Architecture are often seen as built upon, and the evolution of, the older concepts of distributed computing and modular programming.

The system of FIG. 1 includes an SOA governance model (108) that provides parameters used in governing a business's SOA, that is, a governed SOA (162). An SOA governance model may be established through use of a consulting group (102), using software tools and business artifacts, and relevant stakeholders (106) of a business. A consulting group may include one or more individuals that guide members of a business in establishing and implementing an SOA governance model. Such individuals typically are not members of the business. Consulting groups often work closely with relevant stakeholders of the business in establishing and implementing an SOA governance model.

A relevant stakeholder (106) of a business is an individual or party that affects, or can be affected by, a business's actions. “Relevant stakeholders,” as the term is used in the specification, refers to stakeholders which are most directly affected by a business's actions with respect to SOA and often have decision making authority with regard to one or more aspects of the SOA governance model. Although only consulting groups and relevant stakeholders are described here with respect to implementing and operating a governance model in accordance with embodiments of the present invention, readers of skill in the art will immediately recognize that many other individuals or group of individuals associated with a business may take part in implementing and operating some or more aspects such a governance model and each such individual or group of individuals and their actions are also well within the scope of the present invention.

The exemplary SOA governance model (108) of FIG. 1 may be implemented and operated according to an SOA vision (104) that may be defined by the consulting (102) and the relevant stakeholders (106) of the business. That is, a consulting group may be used to guide relevant stakeholders through a process of identifying an SOA vision which may be used to define not only primary boundaries of the business's SOA, but also a governance model for the SOA. An SOA vision (104) is a general and broad definition of SOA goals to be accomplished through use of an SOA. An example of such an SOA strategy which may be accomplished through use of an SOA, is to reduce redundancy in the use of different software applications that provide similar functionality to different organizational entities of the business. Consider, for example, that a retail sales department and an online sales department use different software applications to provide the similar function of receiving and processing customer orders. An SOA vision may outline business goals of the SOA that may be implemented that reduce such redundancy by providing a single service of customer order receipt and processing to both the retail sales department and the online sales department of the business.

As mentioned above, an SOA governance model (108) provides parameters used in governing a business's governed SOA (162). The exemplary SOA governance model (108) of FIG. 1, for example, includes several SOA governance processes (110). An SOA governance process (110) is a processes that when executed governs one or more governed SOA processes (110), the governed processes typically used in implementing, operating, maintaining, and managing an SOA for a business. That is, the governance processes, when executed, effect governance of the typical implementation, operation, maintenance, and management of an SOA for a business.

The exemplary SOA governance model (108) of FIG. 1 the SOA includes a vitality (112) governance processes, a compliance (114) governance process, a communication (116) governance processes, and an appeals (118) governance process. The vitality (112) governance process maintains the applicability of the SOA governance model. The vitality process ensures that the governance model is current, reflecting current business and information technology and strategy, and also refines other governance processes and governance mechanisms to ensure continued usage and relevance of the governance model.

The compliance (114) governance process governs the review and approval processes used in implementing and managing services within an SOA. The governance processes includes providing criteria defined in the establishment of an SOA governance model to guide such review and approval processes. Such criteria may include a business's principles, standards, defined business roles, and responsibilities associated with those defined business roles.

The communication (116) governance process governs communication of SOA vision, SOA plans, and the SOA governance model to members of the business for educating such members. The communication governance process ensures that governance is acknowledged and understood throughout a business and also provides, to members of the business, environments and tools for easy access and use of information describing an SOA governance model.

The appeals (118) governance process enables members of a business to appeal SOA decisions. This appeals governance process therefore also provides exceptions to business policies, information technology policies, and other criteria that must typically be met within SOA decision-making processes.

As mentioned above, each of the governance processes when executed governs one or more governed processes. A governed process is a processes used in implementing, operating, maintaining, and managing an SOA for a business. The exemplary SOA governance model (108) of FIG. 1 includes categories of governed processes (122, 124, 126, 128). Each category represents an area of SOA implementation, operation, maintenance, and management carried out by the governed processes included in the category.

The categories of governed processes in the example of FIG. 1 include strategy (122), design (124), transition (126), and operation (128). Processes included in the category of strategy (122) generally carry out an initial planning of service implementation. Examples of governed processes included in the category of strategy include a process for defining SOA strategy (130), defining service funding (132), and defining service ownership (134). Processes included in the category of design (124) generally carry out identification and definition of particular services for an SOA. Examples of governed processes included in the category of design include a process for modeling services (136), designing services (138), and defining service architecture (140). Processes included in the category of transition (126) generally carry out implementation of services in an SOA. Examples of governed processes included in the category of transition (126) include a process for service assembly (142), service testing (144), service deployment (146), and service delivery (147). Processes included in the category of operation (128) generally carry out management and monitoring of services operating within an SOA. Examples of governed processes included in the category of operation (128) include a process for service monitoring (148), security management (150), and service support (152).

The SOA governance processes (110) of FIG. 1 are executed and implemented by one or more implementation, execution and monitoring tools (154). Such implementation tools may include governance mechanisms (156). Governance mechanisms (156) may include one or more individuals, organizational entities, and business infrastructure to carry out governance according to the governance model (108). Such individuals may include relevant stakeholders, committees, or boards responsible for carrying out such governance. Organizational entities may include, for example, a board of directors, management groups, departments within a business, and the like. Business infrastructure may include available human labor, software applications, database management systems, computer technology, funding, and other types of business infrastructure as will occur to those of skill in the art. Different governance mechanisms (156) may be responsible for carrying out governance of different categories (122,124,126,128) of governed processes (120).

Other exemplary implementation and execution tools (154) in the exemplary system of FIG. 1 include policies, standards, and procedures (158). Policies, standards, and procedures (158) are embodiments of a business's overall business principles and are typically used in guiding decision-making in many of the governed processes (120). That is, policies, standards, and procedures (158) are compliance requirements, defined according to the business's SOA.

Other exemplary implementation, execution, and monitoring tools (154) in the exemplary system of FIG. 1 include monitors and metrics (160). Monitors are typically used to gather data describing performance of governed processes (120) and SOA governance processes (110). The data describing performance of governed processes and SOA governance processes may be compared to specified metrics in order to determine whether the performance of the governed processes and SOA governance processes is weak or strong. The metrics may also be used to identify particular steps of governed processes (120) and SOA governance processes (110) are ripe for improvement. As such monitors and metrics may be used to increase the efficiency and overall effectiveness of not only the governed processes typically used in implementing, operating, maintaining, and managing an SOA (162), but may also be used to increase the efficiency and overall effectiveness of the SOA governance processes (110) that govern such governed processes (120).

The arrangement of governance processes, governed processes, implementation and execution tools making up the exemplary system illustrated in FIG. 1 are for explanation, not for limitation. Systems useful according to various embodiments of the present invention may include additional computer technology, software applications, servers, routers, devices, architectures, organizational entities, and business members not shown in FIG. 1, as will occur to those of skill in the art. Networks in such systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms.

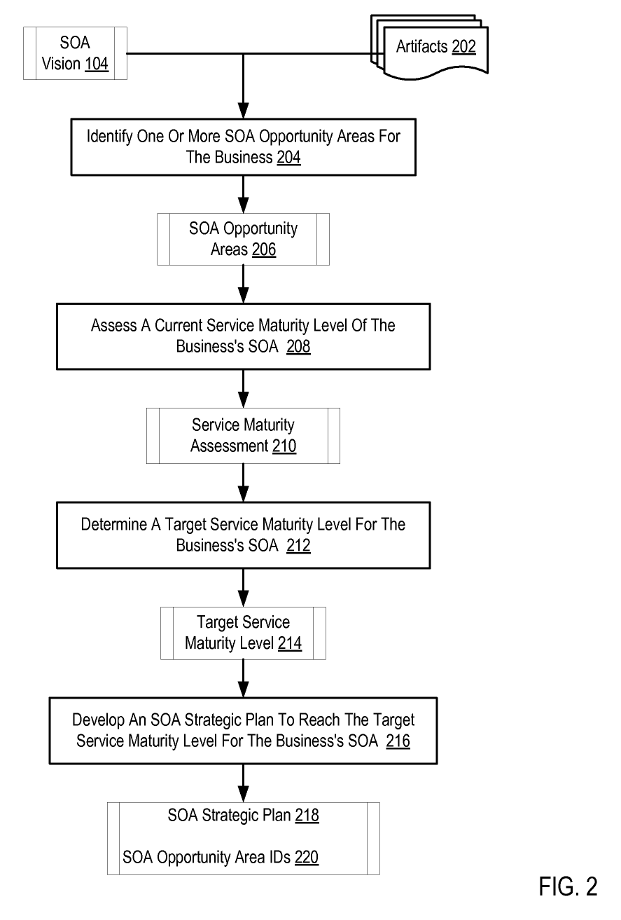

As mentioned above with respect to FIG. 1, an SOA governance model includes several SOA processes that are governed by several SOA governance processes. These SOA processes, so-called governed processes are used in implementing, operating, maintaining, and managing an SOA for a business. The remaining Figures in this specification describe in detail various embodiments of one exemplary governed process used in governing an SOA in accordance with an SOA governance model. For further explanation, therefore, FIG. 2 sets forth a flow chart illustrating an exemplary method for defining SOA strategy for an SOA according to embodiments of the present invention.

The method of FIG. 2 includes identifying (204), in dependence upon a business's SOA vision (104) and one or more artifacts (202) describing a current state of a business's SOA, one or more SOA opportunity areas (206) for the business. Identifying (204) one or more SOA opportunity areas (206) for the business may be carried out by one or more business members, typically working with a consulting group, through use of various technological tools such as computers, software applications, web servers, spreadsheets, databases, networks, aggregations of software and hardware, and other tools as will occur to those of skill in the art.

SOA vision (104) is a general and broad definition of SOA goals to be accomplished through use of an SOA. An example of such an SOA goal which may be accomplished through use of an SOA, is to reduce redundancy in the use of different software applications that provide similar functionality to different organizational entities of the business. Consider, for example, that a retail sales department and an online sales department use different software applications to provide the similar function of receiving and processing customer orders. An SOA vision may outline business goals of the SOA that may be implemented that reduce such redundancy by providing a single service of customer order receipt and processing to both the retail sales department and the online sales department of the business.

An artifact describing a current state of a business's SOA is any information available to a business that describes various aspects of the implementation, management, and operation of a business's SOA, services within the business's SOA, and the business's current and previous SOA vision. Artifacts describing a current state of a business's SOA may include, for example, explicit documentation regarding business infrastructure and information technology infrastructure used in operating the business's SOA as it currently exists. Artifacts describing a current state of a business's SOA may also include, for example, information gathered from one or more business members regarding the business infrastructure and information technology infrastructure used in operating the business's SOA as currently exists.

“SOA opportunity areas” as the term is used in the specification refers to areas of a business's SOA which may be improved to provide to accomplish the goals set forth by the business's SOA vision. Examples of SOA opportunity areas may include particular services, funding of services, service ownership, and so on as will occur to those of skill in the art.

The method of FIG. 2 also includes assessing (208) a current service maturity level (210) of the business's SOA. A current service maturity level (210) of the business's SOA is a general description of the business's currently existing SOA with respect to the business's newly defined SOA vision, a ‘snapshot’ of the current operational state of services in the SOA. This current service maturity level provides a baseline to which later attained maturity levels may be compared to determine an amount of improvement and from which target service maturity levels may be set for modifying the business's currently existing SOA to achieve goals of a newly defined or modified SOA vision.

The method of FIG. 2 also includes determining (212) a target service maturity level (214) for the business's SOA. A target service maturity level is a maturity level of the business's SOA that must be met in order for the business's SOA to achieve the goals of the business's SOA vision. Determining (212) a target service maturity level (214) for the business's SOA may be carried out by one or more business members, typically working with a consulting group, through use of various technological tools such as computers, software applications, web servers, spreadsheets, databases, networks, aggregations of software and hardware, and other tools as will occur to those of skill in the art.

The method of FIG. 2 also includes developing (216) an SOA strategic plan (218) to reach the target service maturity level (214) for the business's SOA. In the method of FIG. 2, the exemplary SOA strategic plan (218) includes identifications (220) of the one or more SOA opportunity areas (206) for the business. Developing (216) an SOA strategic plan (218) to reach the target service maturity level (214) for the business's SOA may be carried out by identifying actions that must be taken within the business to reach the target service maturity level for each of the identified SOA opportunity areas. Such actions may include creating or restructuring one or more service domains, developing and implementing one or more particular services, redefining funding models for one or more services, restructure businesses entities, and so on as will occur to those of skill in the art.

From time to time the method of FIG. 2, that is, the method of defining service strategy for an SOA, may be improved. Such improvement is enabled by gathering metrics describing effectiveness of one or more steps of method of defining service strategy for an SOA. These metrics may be used by relevant business members to identify areas of the method where improvement may be made. Then the relevant business members may modify, in dependence upon the gathered metrics, the method of defining service strategy for an SOA, thereby improving the overall effectiveness of the method.

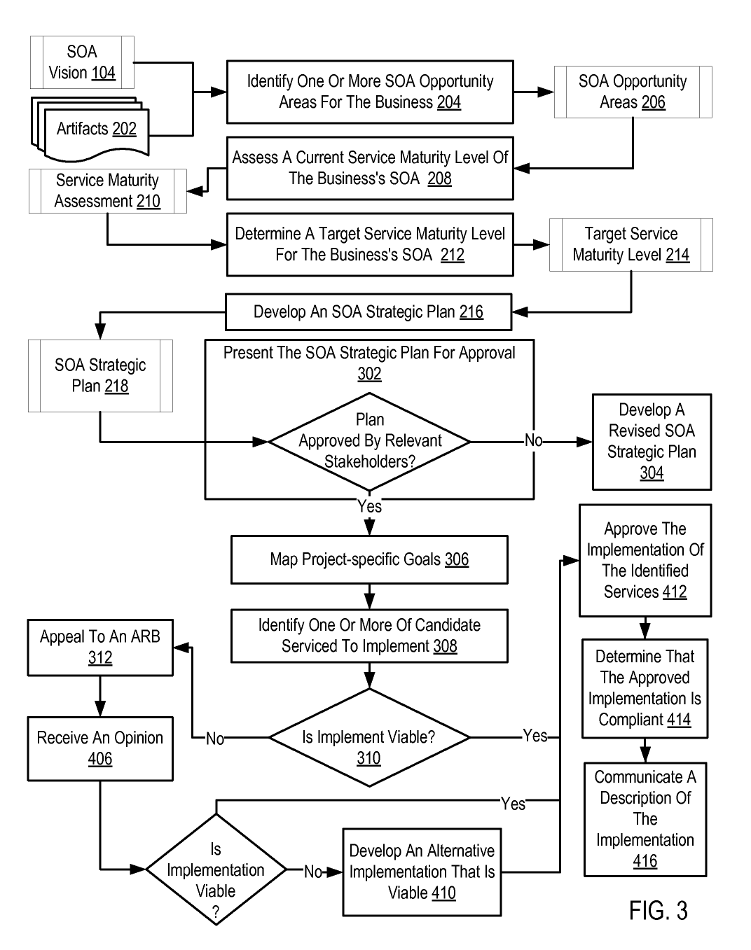

For further explanation, FIG. 3 sets forth a flow chart illustrating a further exemplary method for defining SOA strategy for an SOA according to embodiments of the present invention. The method of FIG. 3 is similar to the method of FIG. 2 in that the method of FIG. 3 also includes identifying (204), in dependence upon a business's SOA vision (104) and one or more artifacts (202) describing a current state of a business's SOA, one or more SOA opportunity areas (206) for the business; assessing (208) a current service maturity level (210) of the business's SOA; determining (212) a target service maturity level (214) for the business's SOA; and developing (216) an SOA strategic plan (218) to reach the target service maturity level (214) for the business's SOA, the SOA strategic plan (218) including an identification (220) of the one or more SOA opportunity areas (206) for the business.

The method of FIG. 3 differs form the method of FIG. 2, however, in that the method of FIG. 3 also includes presenting (302) the SOA strategic plan (218) to the business's relevant stakeholders for approval, and if the business's stakeholders disapprove the SOA strategic plan, developing (304) a revised SOA strategic plan to reach the target service maturity level for the business's SOA. The relevant stakeholders may disapprove the SOA strategic plan for various reasons, including, for example, an excessive cost of executing the strategic plan, an excessive amount of organizational change, the SOA strategic plan does not adequately address each and every goal set forth in the business's SOA vision, and so on as will occur to those of skill in the art. A revised SOA strategic plan may be developed to address the relevant stakeholders various reasons for disapproving the SOA strategic plan, in a manner identical to the development of the original and disapproved strategic plan: identifying one or more SOA opportunity areas, assessing a current service maturity level of the business's SOA, determining a target service maturity level for the business's SOA, then developing the revised SOA strategic plan.

If the business's relevant stakeholders approve the SOA strategic plan, however, the method of FIG. 3 continues by mapping (306) to the developed SOA strategic plan, in dependence upon a project plan for a particular project of implementing one or more candidate services within the business's SOA, project-specific goals and identifying (308), in dependence upon the mapping of project-specific goals to the developed SOA strategic plan, one or more of candidate services to implement. Mapping is carried out by associating project-specific goals to goals of the SOA vision which intended to be achieved by executing the SOA strategic plan. Once the project-specific goals are mapped to goals of the SOA vision, one or more business members may identify one or more of candidate services to implement by identifying those candidate services in the project plan associated with the project-specific goals. That is, once a particular project is initiated, one or more business members determine through use of this process of mapping which candidate services should be implemented in order to comply with the SOA strategic plan and thereby address goals of the business's SOA vision.

The method of FIG. 3 also includes determining (310) whether implementation of the identified one or more candidate services is viable. A ‘viable’ service is a service which a business is physically capable of implementing within defined policies governing such implementation of services. Determining (310) whether implementation of the identified one or more candidate services is viable may be carried out in various ways including, for example, determining whether an appropriate service domain exists for the candidate services that are viable, determining whether sufficient business and IT infrastructure and assets exist to develop, implement, and operate the candidate services, and so on as will occur to those of skill in the art.

If implementation of the identified one or more candidate services is viable, the method of FIG. 3 continues by approving (412), by any relevant business's stakeholders, the implementation of the identified services, determining (414) that the approved implementation of the identified services is compliant with the business's standards and policies, and communicating (416), to one or more relevant business's members, a description of the implementation of the identified services.

Determining (414) that the approved implementation of the identified services is compliant is carried out by comparing various aspects of the development, initiation, operation, and management of identified services with predefined rules, governing such aspects, the rules in accordance with the business's standards and policies.

Communicating (416), to one or more relevant business's members, a description of the implementation of the identified services may be carried out by tailoring, for communication in dependence upon classifications of the relevant members of the business, the description of the implementation of the identified services. That is, different members of the business may be classified differently and may therefore require different description of the implementation of the identified services. The chief executive officer of a business for example may require a different description of the implementation of the identified services than that required by an information technology manager due to the business roles which each member provides.

Returning to step 310 of the method of FIG. 3: If implementation of the identified one or more candidate services is not viable, the method of FIG. 3 continues by appealing (312) the determination that the implementation of the candidate service is not viable to an Architectural Review Board (‘ARB’). An ARB is one or more members of a business that are assigned the responsibility of reviewing appeals from a determination that candidate services are not viable. Appealing (312) the determination that the implementation of the candidate service is not viable may be carried out by providing the ARB with an implementation plan that describes one or more viable implementations of the candidate service.

After appealing (312 in FIG. 3), to the ARB, the determination that the implementation of the candidate service is not viable, the method of FIG. 3 continues by receiving (406), from the ARB, an opinion as to whether implementation of the candidate service is viable. If the opinion of the ARB is that implementation of the candidate service is not viable, the method of FIG. 3 continues by developing (410) an alternative implementation of the candidate service that is viable. When the alternative implementation is viable the method of FIG. 3 continues by approving (412), by any relevant business's stakeholders, the implementation of the identified services, determining (414) that the approved implementation of the identified services is compliant with the business's standards and policies, and communicating (416), to one or more relevant business's members, a description of the implementation of the identified services as described above.

If the opinion of the ARB is that implementation of the candidate service is viable, however, the method of Figure continues by approving (412), by the business's relevant stakeholders, the implementation of the candidate service; determining (414) that the approved implementation of the candidate service is compliant with the business's standards and policies; and communicating (416), to one or more relevant members of the business, a description of the implementation of the candidate service as described above.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of defining SOA strategy for a Service Oriented Architecture (‘SOA’), the method comprising:
identifying, in dependence upon a business's SOA vision and one or more artifacts describing a current state of a business's SOA, one or more SOA opportunity areas for the business;
assessing a current service maturity level of the business's SOA;
determining a target service maturity level for the business's SOA; and
developing an SOA strategic plan to reach the target service maturity level for the business's SOA, the SOA strategic plan including an identification of the one or more SOA opportunity areas for the business.

2. The method of claim 1 further comprising:
presenting the SOA strategic plan to the business's relevant stakeholders for approval; and
if the business's stakeholders disapprove the SOA strategic plan, developing a revised SOA strategic plan to reach the target service maturity level for the business's SOA.

3. The method of claim 1 further comprising:
presenting the SOA strategic plan to the business's relevant stakeholders for approval; and
if the business's relevant stakeholders approve the SOA strategic plan:
mapping to the developed SOA strategic plan, in dependence upon a project plan for a particular project of implementing one or more candidate services within the business's SOA, project-specific goals;
identifying, in dependence upon the mapping of project-specific goals to the developed SOA strategic plan, one or more of candidate services to implement; and
determining whether implementation of the identified one or more candidate services is viable.

4. The method of claim 3 further comprising:
approving, by any relevant business's stakeholders if the implementation of the identified one or more services is viable, the implementation of the identified services;
determining that the approved implementation of the identified services is compliant with the business's standards and policies; and
communicating, to one or more relevant business's members, a description of the implementation of the identified services.

5. The method of claim 4 wherein communicating, to one or more relevant business's members, a description of the implementation of the identified services further comprises:
tailoring, for communication in dependence upon classifications of members of the business, the description of the implementation of the identified services.

6. The method of claim 3 further comprising:
appealing, if the implementation of the identified one or more services is not viable, the determination that the implementation of the candidate service is not viable to an Architectural Review Board (‘ARB’).

7. The method of claim 6 further comprising:
receiving, from the ARB, an opinion as to whether implementation of the candidate service is viable; and
if the opinion of the ARB is that implementation of the candidate service is not viable:
developing an alternative implementation of the candidate service that is viable.

8. The method of claim 6 further comprising:
receiving, from the ARB, an opinion as to whether implementation of the candidate service is viable; and
if the opinion of the ARB is that implementation of the candidate service is viable:
approving, by the business's relevant stakeholders, the implementation of the candidate service;
determining that the approved implementation of the candidate service is compliant with the business's standards and policies; and
communicating, to one or more relevant members of the business, a description of the implementation of the candidate service.

9. The method of claim 1 further comprising:
gathering metrics describing effectiveness of one or more steps of the method of defining an SOA strategy for the business's SOA; and
modifying, in dependence upon the gathered metrics, the method of defining an SOA strategy.

10. A system of defining SOA strategy for a Service Oriented Architecture (‘SOA’), the system comprising:
means for identifying, in dependence upon a business's SOA vision and one or more artifacts describing a current state of a business's SOA, one or more SOA opportunity areas for the business;
means for assessing a current service maturity level of the business's SOA;
means for determining a target service maturity level for the business's SOA; and
means for developing an SOA strategic plan to reach the target service maturity level for the business's SOA, the SOA strategic plan including an identification of the one or more SOA opportunity areas for the business.

11. The system of claim 10 further comprising:
means for presenting the SOA strategic plan to the business's relevant stakeholders for approval; and
means for developing, if the business's stakeholders disapprove the SOA strategic plan, a revised SOA strategic plan to reach the target service maturity level for the business's SOA.

12. The system of claim 10 further comprising:
means for presenting the SOA strategic plan to the business's relevant stakeholders for approval; and
if the business's relevant stakeholders approve the SOA strategic plan:
means for mapping to the developed SOA strategic plan, in dependence upon a project plan for a particular project of implementing one or more candidate services within the business's SOA, project-specific goals;
means for identifying, in dependence upon the mapping of project-specific goals to the developed SOA strategic plan, one or more of candidate services to implement; and
means for determining whether implementation of the identified one or more candidate services is viable.

13. The system of claim 12 further comprising:
means for approving, by any relevant business's stakeholders if the implementation of the identified one or more services is viable, the implementation of the identified services;
means for determining that the approved implementation of the identified services is compliant with the business's standards and policies; and
means for communicating, to one or more relevant business's members, a description of the implementation of the identified services.

14. The system of claim 13 wherein communicating, to one or more relevant business's members, a description of the implementation of the identified services further comprises means for:
tailoring, for communication in dependence upon classifications of members of the business, the description of the implementation of the identified services.

15. The system of claim 12 further comprising:
means for appealing, if the implementation of the identified one or more services is not viable, the determination that the implementation of the candidate service is not viable to an Architectural Review Board (‘ARB’).

16. The system of claim 15 further comprising:
means for receiving, from the ARB, an opinion as to whether implementation of the candidate service is viable; and
if the opinion of the ARB is that implementation of the candidate service is not viable:
means for developing an alternative implementation of the candidate service that is viable.

17. The system of claim 15 further comprising:
means for receiving, from the ARB, an opinion as to whether implementation of the candidate service is viable; and
if the opinion of the ARB is that implementation of the candidate service is viable:
means for approving, by the business's relevant stakeholders, the implementation of the candidate service;
means for determining that the approved implementation of the candidate service is compliant with the business's standards and policies; and
means for communicating, to one or more relevant members of the business, a description of the implementation of the candidate service.

18. The system of claim 10 further comprising:
means for gathering metrics describing effectiveness of one or more steps of the system of defining an SOA strategy for the business's SOA; and
means for modifying, in dependence upon the gathered metrics, the system of defining an SOA strategy.
